(19) United States
(12) Patent Application Publication
(10) Pub. No.: US 2026/0298196 A1
(43) Pub. Date: Oct. 1, 2026

(54) IMPROVEMENTS RELATING TO WIND TURBINE PITCH SYSTEMS

(71) Applicant: Vestas Wind Systems A/S, Aarhus N. (DK)

(72) Inventors: Erik Garde, Randers SV (DK); Pedros Jose De Freitas, Risskov (DK); Anders Fanoe Kjaergaard Nielsen, Aarhus N. (DK)

(73) Assignee: Vestas Wind Systems A/S, Aarhus N. (DK)

(21) Appl. No.: 19/490,978

(22) PCT Filed: May 15, 2024
(86) PCT No.: PCT/DK2024/050115

§ 371 Date: Dec. 8, 2025

(30) Foreign Application Priority Data
Jun. 21, 2023 (DK) PA202370321

(51) Int. Cl. F03D 1/06

(52) U.S. Cl. CPC F03D 1/0667; F05B 2260/79

(57) ABSTRACT

A linear actuator for a pitch system of a wind turbine, comprising an actuator body and an actuator rod which is movable linearly with respect to the actuator body along an actuator axis. In one example, the linear actuator is in the form of a hydraulic actuator or ‘ram’ such that the actuator body is a hydraulic cylinder and the actuator rod is a cylinder rod. The actuator rod has a rod end and a rod end coupling attached to the rod end. The rod end coupling comprises a housing that receives the rod end, wherein at least one interference element is received in a recess in a circumferential part of the rod end. The at least one interference element is constrained in a radial direction within the recess by the housing, wherein the recess is shaped to prevent axial movement of the interference element in an outward axial direction away from the actuator body thereby to prevent axial movement of the housing in the outward axial direction and wherein the rod end coupling further comprises a connector bearing, wherein the housing bears against the connector bearing which prevents axial movement of the housing in an inner axial direction towards the actuator body relative to the actuator rod.

### TECHNICAL FIELD

The present invention relates generally to pitch systems for wind turbines, and an actuator arrangement suitable for such a pitch system.

### BACKGROUND

Wind turbines typically include a rotor with large blades driven by the wind. The blades convert the kinetic energy of the wind into rotational mechanical energy. Typically, the mechanical energy is transferred via a drive train to a generator, which then converts the energy into electrical power.

Most modern wind turbines control power output by pitching the blades relative to the wind which thereby controls the mechanical torque input to the generator. Therefore, each blade is mounted to a hub by a pitch system that allows relative rotational movement between the blade and the hub. The pitch system comprises a pitch bearing, which typically includes concentric inner and outer bearing rings. One of the bearing rings (either the inner or the outer ring) is attached to the blade and the other is attached to the hub. Such pitch systems are in general known technology.

The pitch system also includes a drive system comprising one or more pitch drive devices such as electric motors or hydraulic or electric linear actuators. The drive devices are used to turn the bearing ring attached to the blade relative to the bearing ring attached to the hub in order to adjust the pitch of the blade by turning the blade about its longitudinal axis.

A technical challenge associated with such pitch actuators is how to couple the actuator rod of the actuator to a coupling point of the pitch ring. Known approaches include bolting directly a suitable coupling head to the actuator rod, or providing the coupling head with a screw thread arrangement to corporate with a mutual thread provided on the actuator rod to enable both components to be screwed together. Both approaches have their draw backs.

It is against this background that the invention has been devised.

### SUMMARY OF THE INVENTION

In accordance with one aspect of the invention, the invention provides a linear actuator for a pitch system of a wind turbine, comprising an actuator body and an actuator rod which is movable linearly with respect to the actuator body along an actuator axis. In one example, the linear actuator is in the form of a hydraulic actuator or ‘ram’ such that the actuator body is a hydraulic cylinder and the actuator rod is a cylinder rod. The actuator rod has a rod end and a rod end coupling attached to the rod end.

The rod end coupling comprises a housing that receives the rod end, wherein at least one interference element is received in a recess in a circumferential part of the rod end. The at least one interference element is constrained in a radial direction within the recess by the housing, wherein the recess is shaped to prevent axial movement of the interference element in an outward axial direction away from the actuator body thereby to prevent axial movement of the housing in the outward axial direction and wherein the rod end coupling further comprises a connector bearing, wherein the housing bears against the connector bearing which prevents axial movement of the housing in an inner axial direction towards the actuator body relative to the actuator rod.

A benefit of the invention is that the rod end coupling is readily disassembled and reassembled onto the rod end, which is an advantage during maintenance, particular in circumstances where the actuator rod must be removed from the actuator body for maintenance purposes. What is more, all the component parts may be formed to be comparatively small in size, apt to be handled by individuals in a maintenance crew.

The recess and the cooperating interference element may take various forms. In one example, the recess may be a circumferentially-extending groove, and wherein the interference element may be in the form of a ring that is received in the groove. In one alternative the interference element may comprise a plurality of separate elements that are arranged in the groove. In this case, the plurality of elements may for example be in the form of ball bearings, or ring fragments. In other examples the at least one recess may comprise a plurality of recesses, each of which receives a respective interference element. For example, the plurality of recesses may be in the form of shallow pits, each of which receives a corresponding interference element such as a ball bearing or barrel-shaped element.

It is envisaged that the interference element is a separate part to the housing which may aid assembly and disassembly. However, in other examples the at least one interference element may be integral with the housing, for example as a portion of the same component of as to be monolithic therewith or press fitted to the housing to behave as a single component.

A portion of the housing may bear against a surface of the at least one interference element that faces in an axial direction with respect to the axis (X) towards the actuator body. The connector bearing may bear directly on a surface of the rod end. In a particularly convenient configuration, the bearing is a spherical bearing and its curved surface may bear against a complementarily curved surface of the rod end.

To aid assembly and disassembly of the rod end coupling, the housing may comprise at least two portions that fit together to constrain the connector bearing, those two housing portions defining a mutual split plane/line where they meet or abut one another. In one example, the split plane is transverse to the rod axis.

In the case where the housing is in two parts, the two housing parts may be secured by appropriate means, which may include one or more bolts, so as to achieve a secure connection and ensure that the housing acts as a single piece so is robust against the forces exerted on it, in use.

Further optional and advantageous features are referenced in the detailed description and the appended claims.

### BRIEF DESCRIPTION OF THE DRAWINGS

In order that the present invention may be more readily understood, embodiments of the invention will now be described, by way of non-limiting example, with reference to the remaining figures, in which:

FIG. 1 has already been described by way of background, which shows an exploded perspective view of a pitch system for a wind turbine in which the examples of the invention may be incorporated;

FIG. 2 is a view of a linear actuator embodying an example of the invention, the actuator comprising an actuator body, in the form of a cylinder, an actuator rod and a rod end coupling attached to a rod end of the actuator rod;

FIG. 3 is a more detailed view of the linear actuator shown in FIG. 2, in which component parts are shown in section;

FIGS. 4a to 4d are a sequence of views showing the assembly of the rod end coupling onto the rod end of the actuator;

FIG. 5 is a schematic view of an alternative rod end coupling.

### DETAILED DESCRIPTION

The invention relates generally to the mechanical coupling between a pitch actuator and a blade bearing. Due to the torque that the pitch actuator must exert on the blade bearing, the mechanical coupling is a highly stressed component that must withstand high cyclical loading patterns without exhibiting excessive fatigue. Further, the mechanical coupling should readily be able to be disassembled in such a way as to promote easy maintenance of other components of the pitch system, such as pitch actuator seals and the like, which typically have to be removed from the actuator by sliding them along and off the actuator rod.

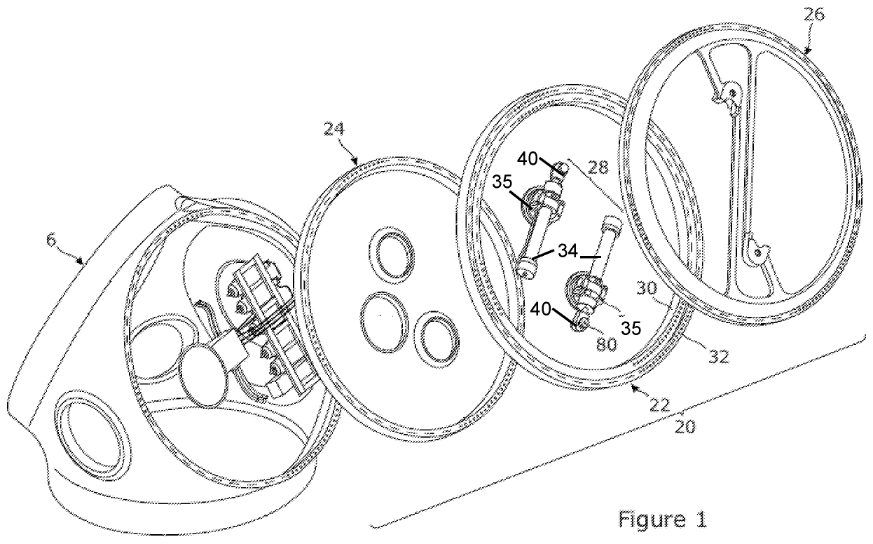

To provide context for the examples of the invention that will be described later, an example of a pitch system for a wind turbine blade is described in the applicant's prior PCT application WO 2012/069062, and a brief overview will be described here. FIG. 1 shows an exploded perspective view of the pitch system described in WO 2012/069062. Referring to FIG. 1, the pitch system 20 includes a bearing 22, first and second coupling members 24, 26, and a drive system 28. More specifically, the bearing 22 includes an inner bearing ring 30 mounted to the hub 6 and an outer bearing ring 32 mounted to the blade (not shown in FIG. 1). The first coupling member 24 is positioned between the hub 6 and the inner bearing ring 30. The second coupling member 26 is positioned between the blade and outer bearing ring 32. The drive system 28 comprises linear actuators 34, which are connected to the first and second coupling members 24, 26 so that the drive system 28 can rotate the inner bearing ring 30 relative to the outer bearing ring 32 and thereby pitch the blade relative to the hub 6.

The first and second coupling members 24, 26 shown in FIG. 1 each comprise a pitch ring for attaching to a respective bearing ring 30, 32. The first coupling member 24 further includes a plate, whilst the second coupling member 26 includes a cross-beam. The plate and cross-beam of the respective coupling members 24, 26 provide mounting points 35 for the linear actuators 34. Each of the linear actuators 34 comprises a respective coupling 40 for connecting to respective connecting points of a respective one of the cross beams.

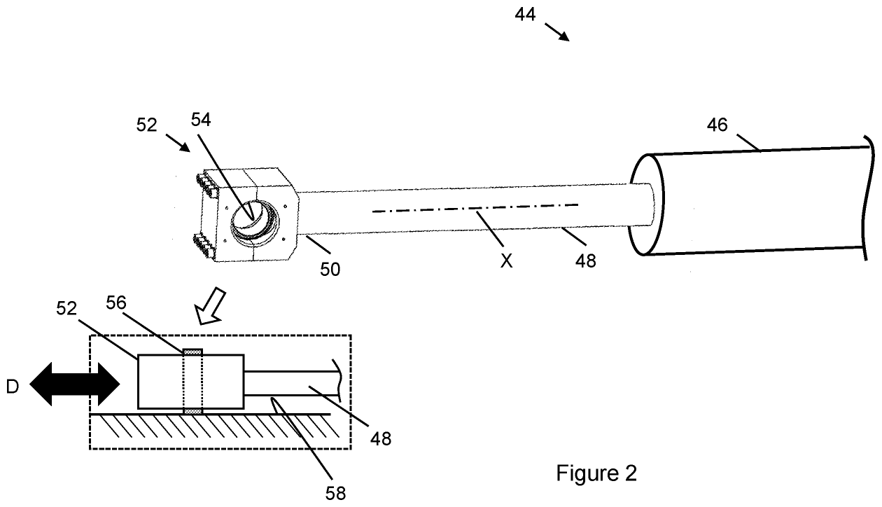

FIG. 2 illustrates a more detailed view of a linear actuator, shown generally at ‘44’ in accordance with an example of the invention which is apt to be used in the pitch system described in FIG. 1.

The linear actuator 44 shown here is a hydraulic linear actuator, but may also be an electrically driven actuator. The term ‘linear actuator’ should not therefore be limited to encompassing only hydraulic systems.

The linear actuator 44 comprises an actuator body in the form of a hydraulic cylinder 46, in this example, and an actuator rod or ‘cylinder rod’ 48 that is slidable with respect to the cylinder 46 along a rod axis X. The cylinder rod 48 has a rod end 50 with a rod end coupling 52 attached to it.

The linear actuator 44 is operable to move the cylinder rod 46 in an axial direction so that the rod end coupling 52 moves along the axial direction towards and away from the cylinder 46, in the usual manner. In this example, the linear actuator 46 is of the hydraulic type and is operated by virtue of a suitable supply of hydraulic fluid (not shown). However, the functionality of the linear actuator 44 is not the focus of the invention and so a full discussion of the operating principle of the linear actuator 44 will not be provided, for the sake of clarity.

The function of the rod end coupling 52 is to provide a means to connect to a control linkage of the pitch system. For this purpose, the rod end coupling 52 defines a central aperture 54 which has an internal form that is shaped to receive a suitable control linkage in the form of an axle 56 that extends from an associated pitch ring 58. Note that the axle 56 and the pitch ring 58 are shown schematically in the inset panel of FIG. 2.

Therefore, axial movement of the rod end coupling 52 in the direction indicated by the arrow D, acts on the axle 56 and thereby actuates the pitch ring 58.

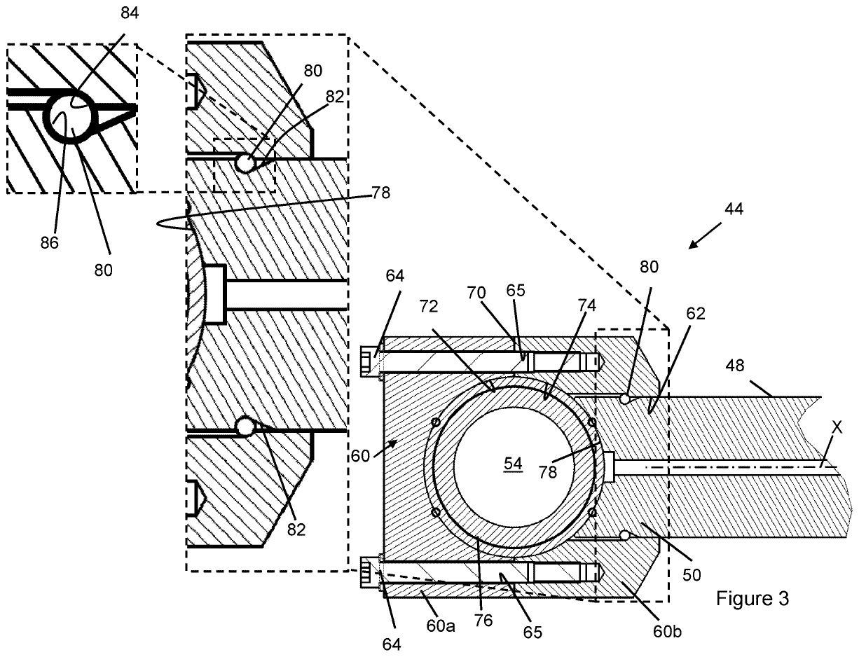

FIG. 3 shows the internal configuration of the rod end coupling 52 in more detail. The rod end coupling 52 comprises a housing 60 that is enlarged with respect to the rod end 50 so that the rod end 50 is received in an axially extending aperture or bore 62 of the housing 60.

From FIG. 3, it will be noted that the housing 60 is an assembly of two parts, thereby comprising a first housing portion 60a and a second housing portion 60b. The two housing portions 60a, 60b are held together by a set of bolts 64 in this embodiment, although in principle other mechanical fastening means would be acceptable. The bolts 64 extend in an axial direction through respective bores defined in both housing portions 60a,60b which are suitably threaded so that the bolts 64 can be tightened thereby securing the housing portions 60a,60b together. Each of the housing portions 60a,60b have an associated end face that mutually abut to define a split line 70 of the housing 60.

Each housing portion 60a,60b is generally C-shaped in form, when considered in a plane that extends along and is perpendicular to the axis X. Therefore, the first housing portion 60a includes a first curved recess or cavity 72 and the second housing portion 60b includes a second curved recess or cavity 74. The two curved recesses 72,74 are generally semi-circular in form, in this example, and form a circular enclosure that encompass a bearing 76 and also define the central aperture 54, once the two housing portions 60a,60b are united. The bearing 76 is a spherical bearing, as is conventional, and so provides the housing 60 a degree of freedom when actuating the axle 46.

It will be noticed in FIG. 3 particularly that the bearing 76 is retained in the housing 60 by being sandwiched in between the two housing portions 60a,60b. More specifically, the bearing 76 is enclosed on one side by the first housing portion 60a and, on its other side by the second housing portion 60b and the rod end 50. Note here, that the rod end 50 defines a curved end surface 78 that forms part of the second curved recess 74 of the second housing portion 60b.

Beneficially, the configuration of the housing 60 enables it to be disassembled from the rod end 50 in a simple manner which provides an advantage in terms of conducting maintenance on the linear actuator 44. In this respect, the housing 60 may be disassembled by removing the bolts 64 which enables the first housing portion 60a to be split from the second housing portion 60b thereby allowing the bearing 76 to be removed from the central aperture 54.

A further benefit of the invention is that the configuration of the two housing portions 60a,60b, the rod end 50 and the bearing 76 means that these components cooperate to lock the housing 60 on the rod end 50 securely in an elegantly simple manner. This is achieved at least in part by an interference element 80 that is held captive between the rod end 50 and the housing 60 when those parts are assembled, and the interlocking geometry of the parts ensures that the housing portions 60a,60b and the bearing 76 are held in place securely on the rod end 50.

The inset panel in FIG. 3 shows detail of the coupling arrangement in enlarged form so that the configuration can be appreciated more fully.

The interference element 80 takes the form of a ring-shaped rod that encircles, at least partly, a recess 82 defined in a circumferential part of the rod end 50. More specifically, the recess 82 is, in this example, a circumferential groove proximate the curved end surface 78 of the rod end 50. The interference element 80 is constrained in a radial direction within the circumferential groove 82 by the housing 60. To enable the interference element 80 to be attached conveniently into the annular groove 82, it may take the form of a circlip so it can be expanded and ‘snapped’ into the groove 82.

As can be appreciated by the detail provided in FIG. 3, the geometry of the second housing portion 60b, the interference element 80 and the rod end 50 are configured to ensure that the housing 60 cannot move axially on the rod end 50 once the housing 60 is assembled and bolted in place. More particularly, the circumferential groove 82 is shaped to prevent axial movement of the interference element 80 in an outward axial direction away from the cylinder 46, relative to the rod end 50, thereby to prevent axial movement of the housing 60 in the outward axial direction.

To this end, the housing 60 and the rod end 50 define a pair of opposed shoulders which bear against the interference element 80. By virtue of this configuration, the interference element 80 is in effect trapped between the opposed shoulders which means that neither the housing 60a nor the rod end 50 is able to move in the axial direction relative to the interference element 80, and thereby are locked in position. At this point it should be noted that all components are envisaged to be made from a rigid material such as steel to ensure accurate manufacturing and tolerances and to ensure that the parts lock together strongly and securely.

In more detail, and as can be seen in the inset panels in FIG. 3, the pair of opposed shoulders comprise a first shoulder 84 defined by the housing 60 and, more specifically, the second housing portion 60b, and a second shoulder 86 defined by the rod end 50 and, more specifically, by the circumferential groove 82 defined in the rod end 50. The first and second shoulders 84, 86 are opposed in the sense that the first shoulder 84 defines an associated abutment surface that faces in an axial direction away from the cylinder 46, whilst the second shoulder 86 defines an abutment surface that faces in an axial direction towards the cylinder 46.

Thus, the housing 60 is unable to move axially in an ‘outward’ direction with respect to the cylinder rod 48 because the first shoulder 84 of the second housing portion 60b is abutted against the interference element 80, and, in turn, the interference element 80 is held by the second shoulder portion 86 of the rod end 50. Moreover, the housing 60 is unable to move in an ‘inner’ axial direction, towards the cylinder 46 because the first housing portion 60a is pressed against the bearing 76 which in turn bears against the end surface 78 of the rod end 50. Moreover, the interference element 80 is constrained in a radial direction, with respect to the axis X, by the shoulder 84 of the second housing portion 60b which urges the interference element 80 against the rod end 50.

Notably, the bearing 76 is in direct contact with the end surface 78 of the rod end 50, which is curved in this example to complement the curvature of the outside surface of the bearing 76. There is a benefit in this configuration because the fact that the rod end 50 bears directly against the bearing 76 means that the load is transferred directly from the actuator rod 48 to the bearing 76 when the actuator rod 48 is extending outwardly. This provides a more robust connection compared to the conventional arrangements where a bearing housing would be connected to the actuator rod by a threaded connection with no direct contact between the rod end and the bearing.

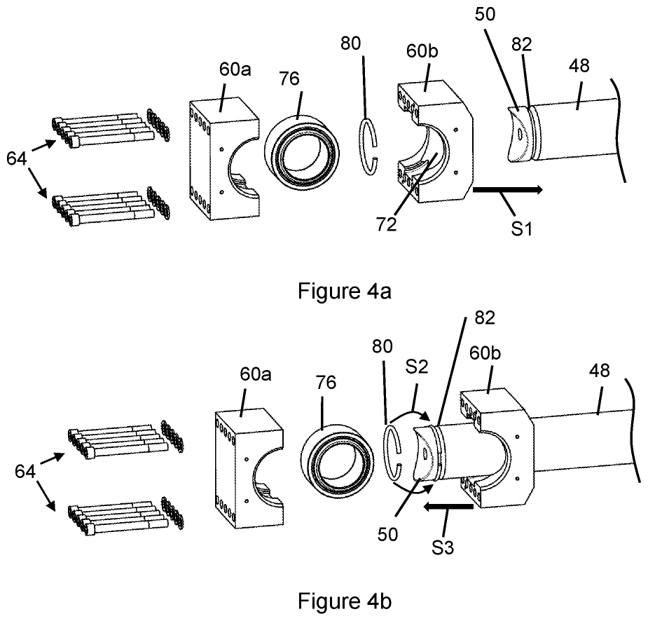

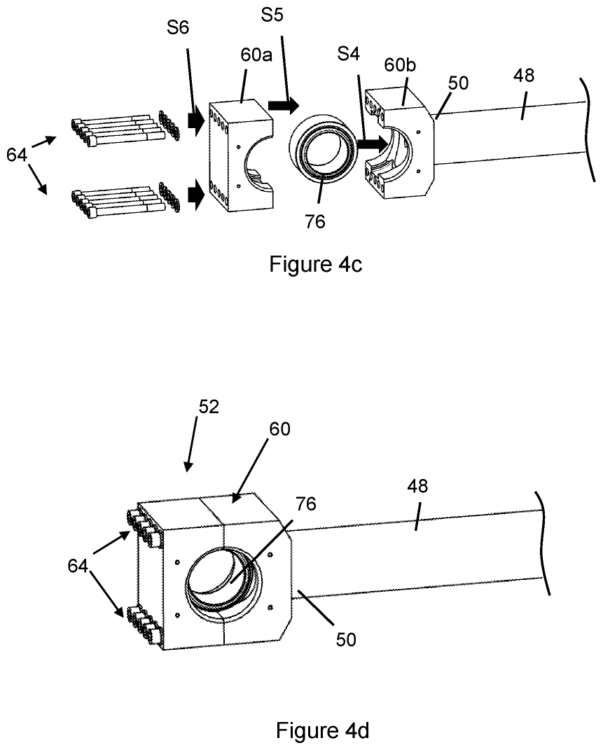

Having described the configuration of the cylinder rod 48, the rod end 50 and the rod end coupling 52, reference will now be made to FIGS. 4a to 4d which show the process of assembling the rod end coupling 52 onto the rod end 50 of the cylinder rod 48.

FIG. 4a shows the individual components of the rod end coupling 52 separated from the rod end 50 in an exploded configuration. Here, the circumferential groove 82 of the rod end 50 can be seen clearly, as can the interference element 80.

As a first assembly step, as indicated by the arrow S1, the second housing portion 60b is moved in an axial direction towards the cylinder 46 (cylinder not shown in FIG. 4a) so that it is received over the rod end 50. In doing so, the rod end 50 is inserted into the axially-extending aperture 72 of the second housing portion 60b.

Once the second housing portion 60b is on the rod end 50, as shown in FIG. 4b, the interference element 80 can be located into the circumferential groove 82, as indicated by the arrows marked S2. When the interference element 80 is in position, the second housing portion 60b can be moved axially in an outwards direction, away from the cylinder 46, until its internal surfaces bear against the interference element 80, as has been described above. This is indicated by the arrow S3, at which point the assembly will be as shown in FIG. 4c.

Following this step, the final assembly can take place, wherein the bearing 76 is located in the cavity of the second housing portion 60b, as indicated in FIG. 4c by arrow S4. Following this, the first housing portion 60a may be brought into abutment with the second housing portion 60b, as in arrow S5, and the set of bolts 64 are used to secure the first housing portion 60a and the second housing portion 60b together as shown by arrows S6. As discussed above, this action locks the rod end coupling 52 to the rod end by virtue of the geometrical interference of the internal surfaces of the housing 60, the interference element 80, the outer surface of the rod end 50 and the bearing 76, to form the completed rod end coupling 52 as shown in FIG. 4d.

The skilled person would appreciate that the illustrated embodiment is one example of how the invention may be put into effect. Accordingly, the embodiment described herein is provided purely for illustrative purposes and is not to be construed as limiting the scope of the invention. Some variations of the illustrated embodiments have been described above, but the skilled person would understand that other variants are possible without departing from the invention as defined by the claims.

By way of example, in the illustrated example the interference element 80 is in the form of a ring-shaped rod that can be expanded to fit over the rod end 50 and snap fit into the circumferential recess or groove 82. It has been described as a separate element to the housing 60 although other configurations have been mentioned.

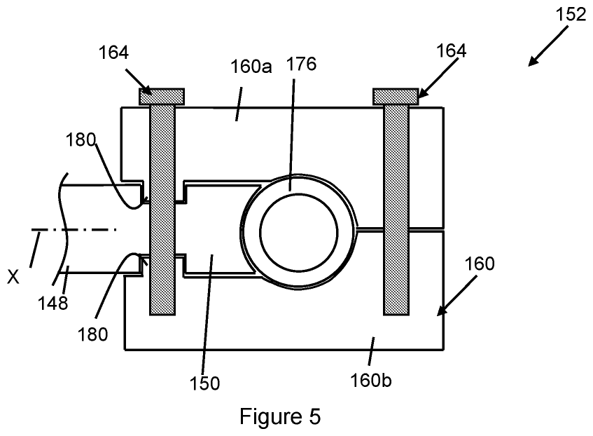

Once such example is shown in FIG. 5. The same or similar parts will use the same reference numerals as in the previously illustrated example, but prefixed with a ‘1’ to distinguish between examples.

As can be appreciated in FIG. 5, the rod end coupling 152 is attached to the rod end 150 of the cylinder rod 148 as in the previous example. The rod end coupling 152 include a housing 160 comprising first and second hosing portions 160a, 160b. However, in this example, the two housing portions 160a, 160b are divided in a different way, so that they are bolted together by bolts 164 which extend in a direction transverse to the axis X of the cylinder rod 148.

By virtue of this arrangement, the first and second housing portion 160a, 160b are brought together from positions either side of the axis X to clamp the rod end 150 and the bearing 176 between them. This provides the opportunity for interference element 180 to be made as a component that is integral to the housing portions 160a, 160b. As before, the interference element 180 is received within the circumferential recess or groove 182 provided in the rod end 150. As shown here, the interference element 180 is integral with the housing portions 160a, 160b in the sense that it is formed from the same piece of material i.e. machined from the same part. However, other configurations are possible in principle.

1. A linear actuator for a pitch system of a wind turbine, comprising:
an actuator body and an actuator rod that defines a rod axis (X) and which is movable with respect to the actuator body along the rod axis, wherein the actuator rod has a rod end and a rod end coupling attached to the rod end,
wherein the rod end coupling comprises:
a housing that receives the rod end,
at least one interference element that is received in a recess in a circumferential part of the rod end,
wherein the at least one interference element is constrained in a radial direction with respect to the axis (X) within the recess by the housing;
wherein the recess is shaped to prevent axial movement of the interference element in an outward axial direction away from the actuator body, thereby to prevent axial movement of the housing in the outward axial direction; and
wherein the rod end coupling further comprises a connector bearing, wherein the housing bears against the connector bearing which prevents axial movement of the housing in an inner axial direction towards the actuator body relative to the actuator rod.

2. The linear actuator of claim 1, wherein the recess is a circumferentially-extending groove, and wherein the at least one interference element is received in the circumferentially-extending groove.

3. The linear actuator of claim 2, wherein the at least one interference element is ring-shaped and encircles at least a portion of the rod end.

4. The linear actuator of claim 1, wherein the at least one interference element is a separate part to the housing.

5. The linear actuator of claim 4, wherein a surface of the housing bears against a surface of the at least one interference element that faces in an axial direction with respect to the axis (X) towards the actuator body.

6. The linear actuator of claim 1, wherein the at least one interference element is integral with a portion of the housing.

7. The linear actuator of claim 1, wherein the connector bearing bears directly on a surface of the rod end.

8. The linear actuator of claim 1, wherein the connector bearing is a spherical bearing.

9. The linear actuator of claim 1, wherein the housing comprises at least two housing portions that fit together to constrain the connector bearing.

10. The linear actuator of claim 9, wherein the at least two portions of the housing define a mutual split plane.

11. The linear actuator of claim 10, wherein the split plane is transverse to the rod axis (X).

12. The linear actuator of claim 9 wherein the at least two housing portions are secured together by one or more bolts.

13. The linear actuator of claim 12, wherein the split plane is transverse to the rod axis (X), and wherein the one or more bolts extend in an axial direction with respect to the axis (X).
